(19) United States
(12) Patent Application Publication
(10) Pub. No.: US 2004/0115361 A1
(43) Pub. Date: Jun. 17, 2004

(54) Method for depositing a film on a substrate

(76) Inventors: Michel A. Aegerter, St. Ingbert (DE); Guillaume Guzman, Veneux-les-Sablons (FR); Jorg Putz, Dudweiler (DE)

Correspondence Address: CORNING INCORPORATED, SP-TI-3-1, CORNING, NY, 14831

(21) Appl. No.: 10/654,460

(22) Filed: Sep. 2, 2003

(30) Foreign Application Priority Data
Sep. 3, 2002 (FR) 02 10866

(51) Int. Cl. B05D 3/02; B05D 1/18

(52) U.S. Cl. 427/430.1; 427/374.1

(57) ABSTRACT

A process for depositing a layer of product on at least part of a major surface of a substrate having two sides separated by a thickness of less than about 3 mm is provided. The process involves using an immersion technique, in which the substrate is placed in a liquid medium containing a solution or dispersion of the product to be deposited or one of its precursors; removed from the liquid medium such that the substrate is coated with a liquid layer, and at least part of the liquid medium contained in the deposited liquid layer is evaporated, wherein the process is characterized as being carried out under conditions in which cooling of the substrate as a result of evaporation of said part of the liquid medium is limited

An advantageous variant of the process involves in heating the immersion bath to a temperature that is sufficient to at least partially compensate for substrate cooling resulting from evaporation of the liquid medium. The inventive process can be used advantageously for depositing a solid layer by means of a sol-gel type process.

### RELATED APPLICATION

This application claims the benefit of priority from French Patent Application No. 02-10866, filed, Sep. 3, 2002, the content of which is incorporated herein by reference.

### FIELD OF INVENTION

The present invention relates to an improved process for depositing a thin layer of a solid product on a thin substrate. More precisely, the invention relates to a method that involves depositing a substance by means of immersion of a substrate in a liquid medium containing a solution or dispersion of the product to be deposited or one of its precursors, followed by evaporation of at least part of the liquid medium.

### BACKGROUND

When depositing a film of a solid substance on a substrate several kinds of techniques may be employed depending on the nature of the substrate and desired surface characteristics. The techniques commonly used to prepare thin-films are generally of either chemical or physical techniques.

One of the most utilized chemical methods for the production of protective or decorative films is by electrolytic deposition which provides a means of depositing metal films from an ionic solution of metal onto a metallic substrate. Anodization, a particular kind of electrolysis, makes use of the aluminum surface as the anode which during electrolysis is being oxidized by reacting with water in the electrolyte to form a nonporous coating of hydrated aluminum oxide thereon. The utility of this process, however, is limited to only a few metals and it has been widely used for the production of tantalum oxide and aluminum oxide barrier films. Also, the brittle nature of the thicker film makes them susceptible to corrosion fatigue which causes local stress cracking and eventual rupture of the films. Other chemical methods include various organic coatings and they are an economically attractive choice for corrosion protection since they are easily handled and applied. Unfortunately, the lifetime of organic coatings is short due to their permeability to corrosive gases.

Physical methods consist of thermal and electron beam evaporation, and sputter deposition. Some techniques involve using a vapour to apply a film deposit (e.g., chemical vapour deposition (CVD)). These methods can produce more pure and well defined films, but the application of these films often requires an expensive vacuum apparatus or a particle-free environment. Other techniques may involve a sol-gel process, or may immerse the substrate to create a coating. All of these techniques have their advantages and desirable applications.

These techniques as practiced conventionally suffer from a new technical problem, which the present inventors were confronted with when applying deposits to exceptionally thin substrates. The inventors observed that transposition of existing techniques for depositing thin, totally transparent layers of an oxide on substrates presented particular problems when applied to substrates of about 3 mm or less in thickness. When the techniques under the same conditions used for thicker substrates were applied to deposit on a thin substrate, the layer acquiring a hazy appearance, thus causing considerable technical difficulties in certain applications where excellent optical quality of the deposit is required.

Japanese patents JP 59042060, JP 63210934 and JP 758453 propose solutions to the problem of tarnishing in thin layers deposited on a substrate after immersion in a solution of the product to be deposited. Nevertheless, these documents do not address the specific problem posed by the deposit of a thin layer on a substrate that is itself particularly thin because these documents cover the deposit of a layer or film on a fairly large cylinder.

Other examples, drawn from the field of surface coating by means of paint projection onto a substrate surface, it is a known practice to heat the nozzle so as to limit the consequences of solvent evaporation in contact with the surface. This problem differs, however, from the problem encountered in the case of deposits resulting from immersion of a substrate in a solution or dispersion of the product to be deposited.

U.S. Pat. No. 5,013,588 (Lin) describes method for imparting a protective or decorative layer to a substrate. The method involves coating a substrate surface with a hydrolyzable solution of silicon alkoxide in an organic solvent. The solvent is evaporated to yield a polymer film, and the film is cured to yield a uniform protective layer on the substrate surface. Although similar, Lin does not describe nor appreciate the technical problem of depositing a thin layer, such as a film, on a thin substrate of under about 3 mm thick, in order to overcome problems related, in particular, to condensation of ambient air on the substrate as a result of its cooling.

In the course of a study conducted by the inventors after the problem was noted, it appeared that not only was no solution available in the literature but that, in addition, no problem such as this had yet been reported. Hence, the present invention addresses provides a solution to this new problem.

### SUMMARY OF THE INVENTION

In view of the foregoing discussion, the present invention provides a solution to the newly appreciated problem encountered when depositing a film on a thin substrate. The inventors discovered that the problem encountered when depositing a thin layer or thin film on a thin substrate was highly specific to thin substrates and related, among other factors, to cooling of the substrate mass as a result of evaporation of the solvent medium when the substrate was removed after immersion in the solvent medium. Coating a glass substrate with a thickness of over 1 mm was generally not a problem whereas, to the contrary, once the thickness was less than 1 mm, a haze formed on the substrate in the final drying stage which greatly detracted from the appearance and optic qualities of the substrate coated with the deposited film.

Studies carried out by the inventors of this invention ascertained that this defect is related to substrate cooling and that a very thin substrate was more sensitive to heat exchanges resulting from evaporation of the solvent and any other volatile compounds contained in the immersion medium. They were thus able to observe that in the final drying step, the temperature of the substrate and deposited film was lower than the temperature of the medium, this reduction in sample temperature stimulating condensation of air on the surface of the deposited film and, therefore, leading to difficulties in controlling film quality after its deposit.

When depositing a solid coating layer on a substrate after its has been immersed in a solution or dispersion of the solid or one of its precursors in a solvent medium, it is necessary to carry out a drying step in order to evaporate the solvents and any volatile organic compounds in the liquid medium.

More precisely, according to an aspect, the method for depositing a layer of product on at least part of the surface of a substrate with two sides separated by a thickness of less than about 3 mm comprises: using a technique involving immersion of the substrate in a liquid medium containing a solution or dispersion of the product to be deposited or one of its precursors, removal of said substrate from the liquid medium and evaporation of at least part of the liquid medium contained in the deposited liquid layer, characterized in that this process is applied under conditions which limit cooling of the substrate caused by evaporation of said part of the liquid medium.

The thickness of the deposited layer evidently depends on the type of product to be deposited and on the conditions of the process carried out for the deposit. Generally, a thickness can be between about 10 nm and about a few hundred μm (e.g., 100-500 or 600 μm). More precisely, in the case of oxides, the thickness of the final layer rarely exceeds about 10 μm to about 25 μm. For mineral materials other than oxides, the thickness of the layer can be a few hundred nm, and for organic-inorganic type mixed materials, the layer can have a thickness of up to a few hundred μm.

In another aspect, the present invention also includes the article produced by the present method.

Other attributes and advantages of the present invention are described in detail in the following description, and with reference to the accompanying FIGS. 1 through 3.

### BRIEF DESCRIPTION OF FIGURES

FIG. 1 is a diagrammatic representation of images taken with an infrared thermal camera during removal from the bath of two samples with different thicknesses, 3 mm and 0.7 mm respectively.

FIG. 2 is also a diagrammatic representation of images taken with an infrared thermal camera which show changes in temperature in the course of drying for two samples with different thicknesses, 3 mm and 0.7 mm respectively.

FIG. 3 is a graph which gives temperature at the centre and base of the sample for two samples with different thicknesses, 3 mm and 0.7 mm respectively.

### DETAILED DESCRIPTION OF THE INVENTION

The invention improves all processes aimed at depositing a solid layer or film on a substrate with two sides separated by a thickness of less than 3 mm. The method involves immersion of a substrate in a liquid medium containing the product to be deposited or one of its precursors, and a so-called evaporation step in the course of which the various volatile products initially found in the immersion bath are eliminated and deposited on the surface of the sample after its removal from the immersion bath. Such processes can include additional steps such as, in particular, chemical transformation steps in the course of which precursor products are transformed into the products finally deposited. In particular, such steps can take place either in an immersion bath or during removal of the substrate from the bath in the course of the evaporation phase. Further, the method may comprise, after the so-called evaporation step, a step of so-called consolidation of the film deposited on the substrate, the consolidation generally taking place by means of thermal treatment.

Even if chemical transformation takes place during immersion and leads to the formation of a gelled layer on the surface of the substrate on its removal from the immersion bath, according to the invention, this layer is called the “liquid layer” as opposed to the desired final layer which is called the “solid layer”.

The sides of the substrate in question can be either flat, with the substrate then being in the form of a plate, or curved, these curved surfaces possibly being sealed, in which case the substrate is in the form of a tube.

A thin substrate has different surface characteristics and thermal properties of the substrate than a thicker substrate, which can affect deposition of a film. Substrates of about less than 3 mm thick provides a threshold from which the defect linked to cooling of the substrate under the effect of evaporation heat of the solvent medium is observed. The thickness about 3 mm depends on the type of substrate material and, in particular, on the heat diffusion properties of the material. As an example, the problem of the quality of deposits begins to become an acute one for glass substrates at a thickness on the order of about 1 mm.

As explained above, this improvement, which constitutes the aim of the invention, applies to all processes for depositing a thin layer such as that defined above, on a thin substrate by immersion of this substrate in a solution or dispersion of the product to be deposited or one of its precursors then removal of the substrate such that it is coated with a liquid layer consisting of, or resulting from after chemical transformation, the solution or dispersion used, followed by evaporation of at least part of the liquid medium contained in the liquid layer deposited to form a solid layer of the product to be deposited, a layer which will optionally be later subjected to thermal post-treatment, the so-called consolidation treatment.

Evaporation begins as soon as the substrate is removed.

Cooling of the substrate during evaporation of the solvent is clearly demonstrated by following temperature changes, using an infrared thermal camera which allows rapid monitoring with excellent resolution, during removal of the substrate from the liquid medium and during the drying step of the deposited liquid film.

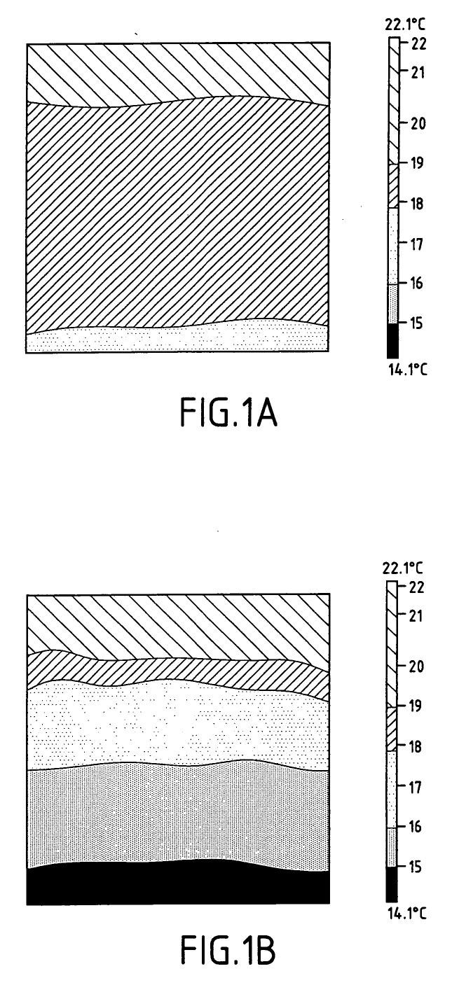

FIG. 1 shows the change in temperature at different points in the substrate in the course of evaporation for a glass substrate with a thickness of 3 mm (FIG. 1A) and 0.7 mm (FIG. 1B).

This phenomenon generally goes unnoticed when the substrate is relatively thick, especially in the case of small substrates.

FIG. 1, obtained from infrared images for the 3 mm substrate (FIG. 1A) and 0.7 mm substrate (FIG. 1B) respectively after immersion of 100 mm×100 mm substrates in ethyl alcohol, clearly shows the effect of substrate thickness on temperature distribution.

In the tests conducted, the substrate was immersed in the solvent over a height of 80 mm then removed at a constant rate.

The start of substrate removal is defined as time t=0. It should be remembered, in the discussion which follows, that the lower zones of the substrate leave the solution later than the higher zones.

In the images in FIGS. 1A and 1B, the lower zones resulting in edge effects are clearly visible from the distribution of temperature values.

In both cases, a 15-20 mm wide zone is found at the base of the substrate which has a lower temperature than that of the centre.

Cooling linked to evaporation is always greater than in the other zones as a result of the larger quantity of solvent.

FIG. 1A particularly shows a parabolic profile with a width of about 10 to 15 mm in the two lateral sides where the temperature is higher than in the zones corresponding to the centre.

Nevertheless, a comparison of FIGS. 1A and 1B essentially reveal that FIG. 1B compared to FIG. 1A shows greater temperature irregularity than the very clearly cooled zone, especially in the lower part of the sample.

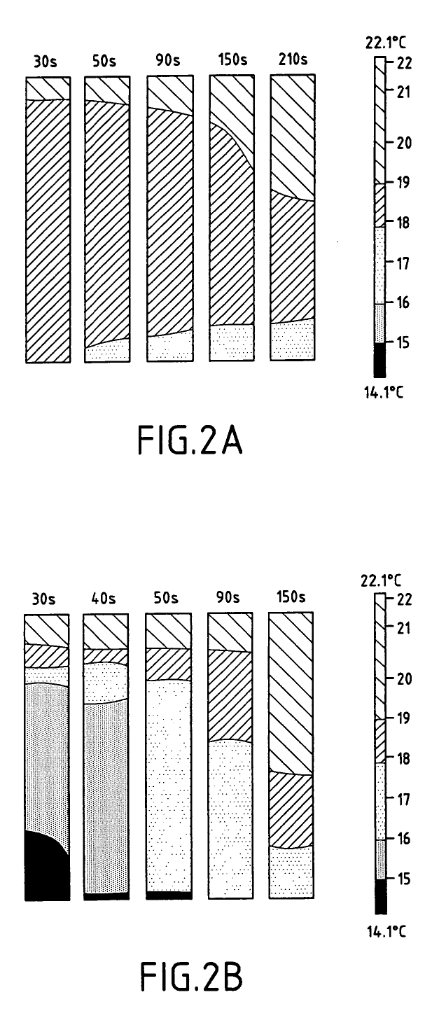

Quantitative analysis of changes in temperature was also carried out. The results of this are given in FIGS. 2A and 2B which respectively represent, for different evaporation times, changes in temperature in the narrow bands at the centre of the samples in the case of the 3 mm and 0.7 mm thick substrates.

FIGS. 1 and 2 thus clearly demonstrate the fundamental problem which this invention aims at resolving, in other words cooling of the substrate as a result of the evaporation of the solvent medium or other volatile compounds contained in the liquid medium in which the substrate is immersed, a problem which is more serious the thinner the substrate.

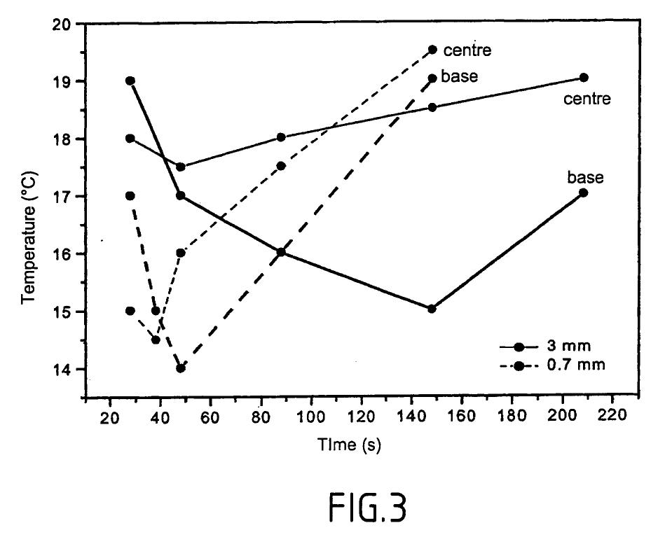

FIG. 3 shows the evolution of temperatures corresponding to the centre and base of the zone as a function of time.

It is very apparent that the 3 mm thick substrate shows a much more homogeneous decrease in temperature up to about 17-18° C. at the centre but that reheating the substrate to room temperature (20° C.) takes over 4 minutes.

A minimum temperature of 15° C. is reached after about 3 minutes at the base of this same sample as a result of the larger amount of solvent left at the base of the sample.

On the other hand, the 0.7 mm thick sample is cooled to a temperature of only 14-15° C. with a slightly lower value at the base of the sample.

The temperature change is not uniform throughout the sample. Reheating happens much more quickly, in under 3 minutes, because of the lower thermal capacity of the thinner sample.

All these observations made by the inventors of this invention regarding variations in substrate temperature in the course of drying demonstrate the impact of solvent evaporation on the properties of the deposited layer. This led to them putting forward a solution to the novel problem they were confronted with when attempting to coat thin substrates.

To overcome this problem, they therefore envisaged applying the solid layer deposit process under conditions which limit substrate cooling by evaporation.

Different approaches could then be explored, taking into consideration that the rate of cooling is an important parameter defined by the heat of evaporation and the rate of evaporation. While the heat evaporation can be determined from data in the literature, the rate of evaporation is not as well known and is not easy to calculate. A large number of parameters are involved in the solvent evaporation phenomenon, including evaporation heat, boiling point, boiling point parameters, viscosity, the surface tension, of the solvent pressure and rate of heat diffusion. All these parameters interact with each other.

Moreover, it is important to choose conditions under which the liquid film has time to form in a uniform manner.

For example, a boiling point that is too low leads to overly quick evaporation and, because of thermodynamic effects, a lack of homogeneity in the film thus formed. On the other hand, a boiling point that is too high results in drying problems because the film may be insufficiently fixed and run the risk of moving over the substrate which could decrease the viscosity of the liquid prior to evaporation.

Ambient humidity is also a parameter to be taken into consideration, especially in the case of a solid deposit involving an intermediate precursor hydrolysis step.

The tests conducted showed that different embodiments can limit substrate cooling resulting from evaporation of the solvent or part of the solvent medium.

According to a first embodiment, it is possible to limit substrate cooling resulting from evaporation of the solvent medium by altering the composition of the liquid medium so as to reduce its heat of evaporation and/or rate of evaporation.

Increasing the molecular weight of the solvent, which leads to an increase in its boiling point, can effectively reduce substrate cooling because of a lower rate of evaporation and a lower enthalpy of evaporation.

It is therefore possible to envisage modifying the conditions of the process in order to influence evaporation conditions.

However, one skilled in the art knows that a change of solvent is generally accompanied by a change in the stability of the liquid medium or a change in the depositing process, which may well require the process to be adapted to new conditions.

This is why this approach, which consists in modifying the composition, of the medium is not generally a preferred solution according to the invention, except in a number of specific cases.

The preferred embodiment of the invention consists in, for a given liquid medium, at least partially compensating for substrate cooling resulting from evaporation of the liquid medium.

According to a preferred variant of this embodiment, this compensation is achieved by heating the solution or dispersion to a temperature sufficient to at least partially compensate for substrate cooling by evaporation.

Evidently, the temperature to which the solution has to be heated is dependent on the conditions of the process, in particular on the type of product to be deposited and the liquid medium. It also depends on the substrate to be coated.

This temperature can be easily established by the one skilled in the art by carrying out simple, routine tests which consist in, all things being equal, gradually increasing the temperature of the immersion bath and visually observing the appearance of samples during the drying step so as to optimise the temperature of the bath in order to minimize the haze effect in the final sample.

In addition to these tests, temperature changes in the substrate mass, during its removal from the immersion bath as well as during the drying period, can be monitored by means of an infrared thermal camera, since, as described previously, the haze which appears after the drying step is directly related to a reduction in substrate temperature.

The person skilled in the art can, by means of a few temperature modification tests, easily establish the optimal temperature to be used for the immersion bath, a temperature which can then be used in later tests to coat a substrate of similar thickness under the same operating conditions.

According to another variant, it is possible to compensate for substrate cooling resulting from evaporation by heating the substrate coated with the liquid layer to an appropriate temperature during removal of the sample from the immersion bath.

Here again, simple tests can be carried out to establish, case by case, the heating time and power to be used to obtain this effect, as well as the distance between the sample and the heating device used.

Heating can, for example, be achieved by means of a heating panel placed at a suitable distance form the sample.

The improved process of the invention is applicable to all solid film deposits on substrates which involve a substrate immersion step in a liquid bath containing the solid to be deposited or its precursor, and evaporation of the liquid medium deposited on the substrate's surface.

The process of the invention is applicable, in a particularly adapted manner, to all processes whereby a film is deposited on a substrate by means of the so-called sol-gel method. Sol-gel methods are well-known processes which generally involve metallo-organic precursors which are hydrolysed in an organic solvent.

The transition from the sol phase to the gel phase is the result of condensation generally followed by poly-condensation of metallic elements giving rise to polymer chains. Depending on temperature, pH and concentration conditions, gels, colloids or precipitates can be obtained. Different variants of this process exist and consist, in particular, in adding organic substances such as simple additives or additives which react with the hydrolysed or unhydrolysed metallo-organic species. In these processes, the organic substances used can be either simple molecules or polymers.

Transition from the sol to gel phase can take place in the immersion bath as well as at the surface of the substrate after the immersion phase.

Sol-gel type processes are advantageously applied to the deposit of oxides, especially metal oxides. Nevertheless, these processes are not limited to the deposit of such substances and other mineral compounds can be deposited, such as sulphides, for example cadmium sulphide or zinc sulphide, or metal particles such as gold particles or different organic/inorganic mixed materials, such as silicones.

The process is of particular interest when applied to deposits carried out, in particular, by means of a sol-gel type process, using a solution or dispersion of a simple or mixed oxide or mixture of oxides, said oxides possibly being doped, or a precursor of these oxides consisting, in particular, of polymer particles or chains based on these oxides onto which are grafted organic radicals such as C₁ to C₁₀ alkyl groups, carboxylate groups, acetate groups or phenyl radicals.

Examples of the type of oxide that can be applied particularly well to such process are silica, titanium oxide, zirconium and alumina.

These oxides can be simple or mixed metal oxides or mixtures of oxides, doped or not with a metal.

The process according to the invention is found to be of particular interest in all applications where a metal oxide layer is to be deposited on a thin substrate.

It is of particular interest in the case of deposits of transparent and conducting metal oxides such as those used in compounds for the optics or electronics industry, especially the display device industry, for example for the development of materials to be used in the manufacture of luminous display devices, in particular organic light-emitting diodes, in which the substrate often consists of a very thin glass or vitroceramic layer, particularly a layer whose thickness is less than 1 mm.

An example of transparent and conducting metal oxides is the group constituted by tin, zinc, indium and cadmium, possibly combined with at least one element selected from the group consisting of gallium, antimony, fluorine, aluminium, magnesium and zinc, said element entering into the composition of said mixed oxide or said mixture of oxides or acting as a doping agent for said oxide.

These oxides can be simple or mixed oxides or mixtures of oxides.

The process of the invention applies to a very broad range of substrates. However, depending on the nature of the substrate, the critical minimum thickness, above or equal to which the process is of particular value, can vary.

The substrate can be a glass substrate, particularly a silica, borosilicate or aluminosilicate substrate.

It can also be a vitroceramic type substrate, that is to say a substrate consisting of a glass containing ceramic oxide type particles within it.

It can also be a substrate consisting of a metal or metal alloy, for example a nickel, aluminium, iron or steel substrate.

It can also be a substrate consisting of a metalloid, for example silicium or germanium.

It can also be a polymer-based substrate, in particular a polycarbonate, vinyl polychloride or polypropylene based substrate.

In the case of glass or vitroceramic substrates, the process according to the invention is of particular interest in improving the optic qualities of a film deposit when the substrate has a thickness of less than 1 mm.

Examples of a deposit on a thin glass or vitroceramic substrate, particularly having a thickness under 1 mm, are deposits of transparent and conducting metal oxides (TCO) using a sol-gel type process which has the advantage of giving a fairly smooth surface.

The sol-gel depositing step is generally followed by a heat consolidation step.

The deposit can be carried out directly on the substrate or on a substrate previously coated with a first layer of another oxide.

The one skilled in the art will evidently choose the operating conditions as a function of the type of oxides to be deposited and the desired thickness.

Depositing a thin layer can be carried out by means of any process known to the one skilled in the art which results in a coating made from a composition in the liquid state incorporating volatile and non-volatile constituents.

With regard to sol-gel type deposits, these conditions are chosen as a function of commercially available precursors.

As an example of precursors for tin oxide deposits, one can choose from SnCl₂(OAc)₂, SnCl₂, a Sn(II) alkoxide such as Sn(OEt)₂, Sn(II)ethyl-2-hexanoate, SnCl₄, a Sn(IV) alkoxide such as Sn(OtBu)₄. Any salt or metallo-organic compound known to be a precursor of tin can also be used.

In the case of antimony oxide deposits, all precursors used for depositing antimony oxides can be used.

In particular, SbCl₃, SbCl₅, Sb(III) alkoxides as well as metallo-organic compounds and salts can be used.

In general, any conventionally used compounds can be employed as metal oxide precursors.

In particular, metallo-organic compounds or salts of these metals can be used.

More precisely, metal oxide precursors are used in solution or in suspension in an organic solvent, for example a volatile alcohol.

Examples of volatile alcohols include linear or branched C1 to C10 alcohols, particularly methanol, ethanol, hexanol and isopropanol.

Glycols can also be used, especially ethylene glycol or volatile esters such as ethyl acetate.

The composition used to deposit an oxide layer can advantageously include other constituents, particularly water or a stabilising agent such as diacetone alcohol, acetylacetone, acetic acid and formamide.

Thus, according to a variant of the invention, the substrate onto which the deposit according to the invention is applied can be previously coated with a first oxide layer, in particular a metal oxide, for example a transparent and conducting metal oxide. For example, as shown in the example attached in the appendix, a glass or vitroceramic substrate can be previously coated with a layer of a transparent and conducting metal oxide such as a layer of indium oxide doped with tin (In₂O₃:Sn), called ITO.

An improved sol-gel process according to the invention can then be used to deposit a second layer of a transparent, conducting oxide, for example a layer of tin oxide doped with antimony (SnO₂:Sb) to level out the surface of the first layer. Application of the second layer is carried out under the conditions of the process according to the invention, in other words under conditions which limit substrate cooling caused by evaporation of the solvent medium and any volatile compounds contained in it.

To obtain these conditions, the example below shows that it is advantageous, when room temperature is about 20° C., to heat the bath in which the substrate to be coated is immersed to 25° C.

### EXAMPLE

The various materials prepared and used were characterized as follows:

a. Measurement of Film Thickness

Film thickness is determined using a TENCOR P10 type needle surface profiler. The values given below are mean values from seven measurements in different positions.

b. Roughness

Peak-valley roughness (Rₚᵥ) and mean roughness (Rᵣₘₛ) were determined using a white light interferometer (Zygo New View 5000) and by atomic force microscopy (AFM technique).

c. Optical Properties

The transmission of samples was measured using a Cary 5E (Varian) type spectrophotometer in the range of 200 to 300 nm using air as a reference for normal incidence.

1. We used a 0.7 mm glass substrate coated with a layer of indium oxide doped with tin (ITO) using a vacuum spraying technique, and sold by Samsung Corning

The ITO layer has the following properties:

thickness of 192 nm,

mean roughness (Rᵣₘₛ) measured over 5 μm² of 4.7 nm,

peak-valley roughness (Rₚᵥ) measured over 5 μm² of 31.1 nm,

transmittance of 83% in the visible range.

2. A layer of tin oxide doped with antimony (ATO) was deposited as follows:

a coating solution is prepared by dissolving tin diacetate dichloride SnCl₂(OAc)₂ in ethanol, as well as 4-hydroxy-4-methyl-pentanone (CAS 123-42-2) as a stabilising agent. The relative amounts of tin and antimony are calculated to give final doping of 7 mol-%. The relative stabilising agent concentration with respect to tin is 2 mol-%.

Ethanol is added to achieve a relative tin concentration of 0.5 mol/l.

This coating solution is deposited by immersing the substrate in this medium at a temperature of 25° C. with a removal rate of 24 cm/min.

After depositing a single layer of ATO, the coated substrate is heated to 550° C. for 15 minutes.

The coating properties are as follows:

optical transmittance: 82%,

coating thickness: 108 nm (+192 nm for ITO),

mean roughness (Rᵣₘₛ): 0.4 nm in a 100 nm² square,

peak-valley roughness (Rₚᵥ): 3.8 nm in a 100 nm² square.

It is found that an ATO layer with the required optical properties is obtained by operating at an immersion bath temperature of 25° C. The optimum temperature used in this test was established by carrying out a set of systematic tests which involved regularly increasing the temperature of the bath from room temperature (about 20° C.) to a temperature at which the deposit has excellent optical qualities, making it possible to avoid any haze effect which would render the coating unacceptable for the required application.

The present invention has been described generally and in detail by way of examples and figures. Persons skilled in the art, however, will understand that the invention is not limited necessarily to the embodiments specifically disclosed, but that modifications and variations can be made without departing from the spirit of the invention. Therefore, unless changes otherwise depart of the scope of the invention as defined by the following claims, they should be construed as being included herein.

We claim:

1. A method for depositing a layer of product on at least a part of a substrate surface, said substrate having two sides separated by a thickness of less than about 3 mm, the method comprising: immersing said substrate in a liquid medium containing a solution or dispersion of said product to be deposited or a precursors of said product; removing said substrate from said liquid medium; and evaporating at least part of the liquid medium contained in the deposited liquid layer from said substrate surface, wherein said process is carried out under conditions in which cooling of the substrate as a result of said evaporation of said part of the liquid medium is limited.

2. The method according to claim 1, wherein said liquid medium has a composition of so as to reduce its heat of evaporation and/or rate of evaporation.

3. The method according to claim 1, wherein for a given liquid medium, the method is carried out by at least partially compensating for substrate cooling resulting from evaporation of the liquid medium.

4. The method according to claim 3, wherein said solution or dispersion is heated to a temperature sufficient to at least partially compensate for substrate cooling by evaporation.

5. The method according to claim 3, wherein said substrate coated with a liquid layer is heated to a temperature sufficient to at least partially compensate for its cooling as a result of evaporation of said liquid medium contained in said liquid layer.

6. The method according to claim 1, wherein a sol-gel type process is used to deposit.

7. The method according to claim 1, wherein said solution or dispersion is a dispersion or solution of a simple oxide, a mixed oxide or mixture of oxides, said oxides possibly being doped, or a precursor of these oxides consisting, in particular, of polymer particles or chains based on these oxides onto which are grafted organic radicals such as C₁ to C₁₀ alkyl groups, carboxylate groups, acetate groups or phenyl radicals.

8. The method according to claim 7, wherein said layer is a metal oxide layer, mixed metal oxide layer or mixture of metal oxides, said metal being doped or not with a metal.

9. The method according to claim 8, wherein said metal oxides are transparent and conducting.

10. The method according to claim 1, wherein said substrate is a glass, vitroceramic, metal, metalloid, or polymer-based substrate.

11. The method according to claim 10, wherein the substrate is a glass or vitroceramic substrate whose thickness is less than 1 mm.

12. The method according to claim 1, wherein said substrate is a glass or vitroceramic substrate whose thickness is less than 1 mm and is coated with a transparent and conducting metal oxide layer.

13. The method according to claim 12, wherein said transparent and conducting metal oxide layer is a layer of indium oxide doped with tin (In₂O₃:Sn).

14. The method according to claim 12, wherein a sol-gel process is used to deposit a layer of tin oxide doped with antimony (SnO₂:Sb) on said glass or vitroceramic substrate previously coated with a layer of indium oxide doped with tin.
